(19) United States
(12) Patent Application Publication
(10) Pub. No.: US 2009/0084011 A1
(43) Pub. Date: Apr. 2, 2009

(54) Kitchen butler

(76) Inventor: Alejandro Enrique Bartley, Brooklyn, NY (US)

Correspondence Address: Alejandro Bartley, 9204 Avenue K, Brooklyn, NY, 11236, US

(21) Appl. No.: 11/824,690

(22) Filed: Oct. 1, 2007

(51) Int. Cl. G09F 7/04; G09F 11/00

(52) U.S. Cl. 40/600

(57) ABSTRACT

The Kitchen Butler is a high-end management system for the household made from durable plastic, which can be attached to a refrigerator via magnets located on the back or hung from any space desired via groves for a hook located on back. The plastic housing “tablet” allows you to view specific imprinted items on a card that can be slid into groves of three slots in a display of five windows. A slider is placed under each item that displays a buy sign when it's moved implying that the item needs to be brought.

### BACKGROUND

It has come to my attention that when a particular household item is need to be purchased an individual has to search to see if they are out of that item and then remember to ad it to a list. With the Kitchen Butler that process is made easy by helping you memories that specific item

### SUMMARY OF THE INVENTION

A visual tool that assist in every day's kitchen activities. Kitchen Butler facilitates and tracks the use of any kitchen item especially when it's time for a trip to the shopping center for groceries, cleaning item, bathrooms items or just about any kitchen item.

This invention “Kitchen Butler” consists of a plastic tablet ¼ inch thick 7½ inches in length by 6 inches in width and 4.10 oz in weight. It can be magnetized onto the refrigerator in the kitchen by four magnets or hung from a wall by its grove. There are three slots, which holds three detachable 7⅓ inches by 1¼ inch sliding cards with five imprinted pictures of every day kitchen items you find in the covert.

On the bottom of every pictured item, there's a slider that conceals a buy sign that can be displayed by sliding the bar over whenever an item needs to be purchased.

### BRIEF DESCRIPTION OF THE SEVERAL VIEWS OF THE DRAWING

FIG. 1 A Rendering for the prototype Kitchen Butler.

FIG. 2 The “kitchen Butler” with sliding interchangeable card.

FIG. 3 The Front view of invention.

FIG. 4A The Front cover of invention.

FIG. 4b The reverse side of front cover of the invention.

FIG. 5 Interchangeable Cards with picture of items.

FIG. 6A Inside view of bottom cover of the invention.

FIG. 6B Back of bottom cover of the invention.

FIG. 7 Side view of the invention.

FIG. 8 Slider for the invention.

### DETAILED DESCRIPTION OF THE INVENTION

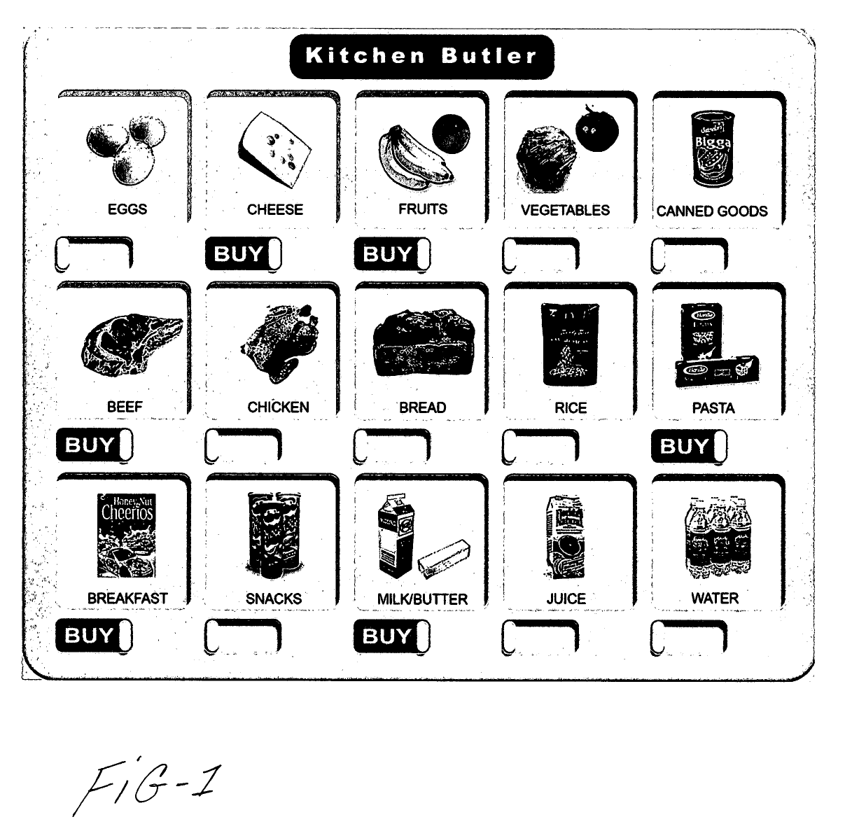

FIG. 1 A rendering of the prototype of the Kitchen Butler.

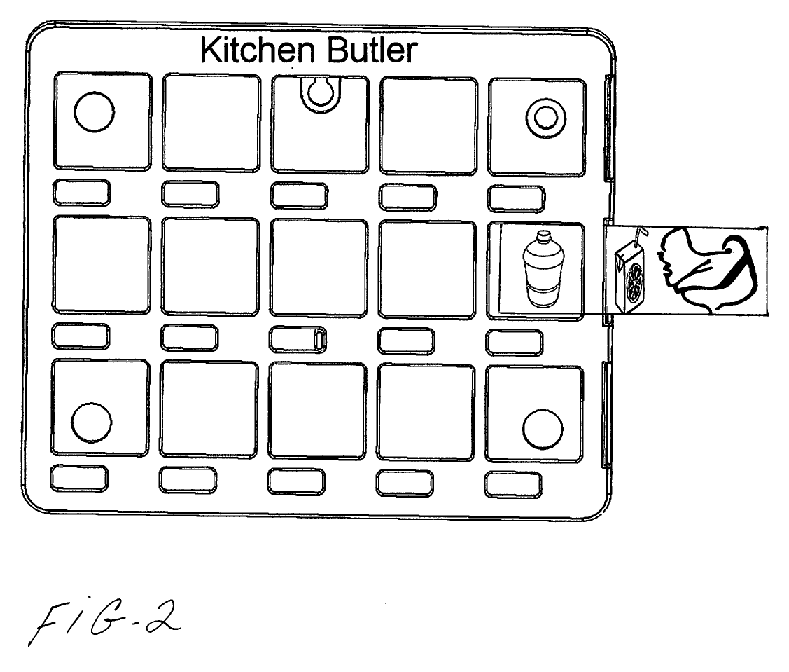

FIG. 2 The kitchen Butler with its sliding cards out.

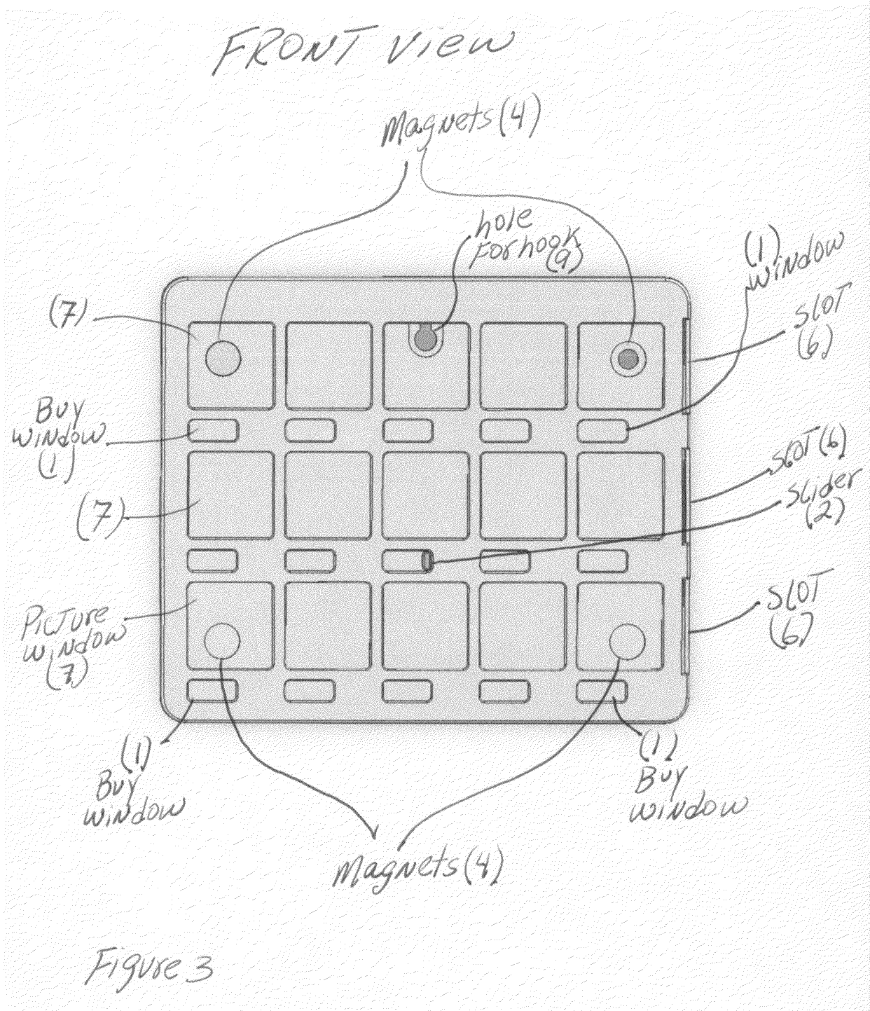

FIG. 3 The front view of the invention. The buy window 1 located under the view window 7 were a picture of an item is viewed. The buy window 1 has a buy sing located under the slider 2 that can be moved to display the buy sing. Magnets 4 located on the back of the invention.

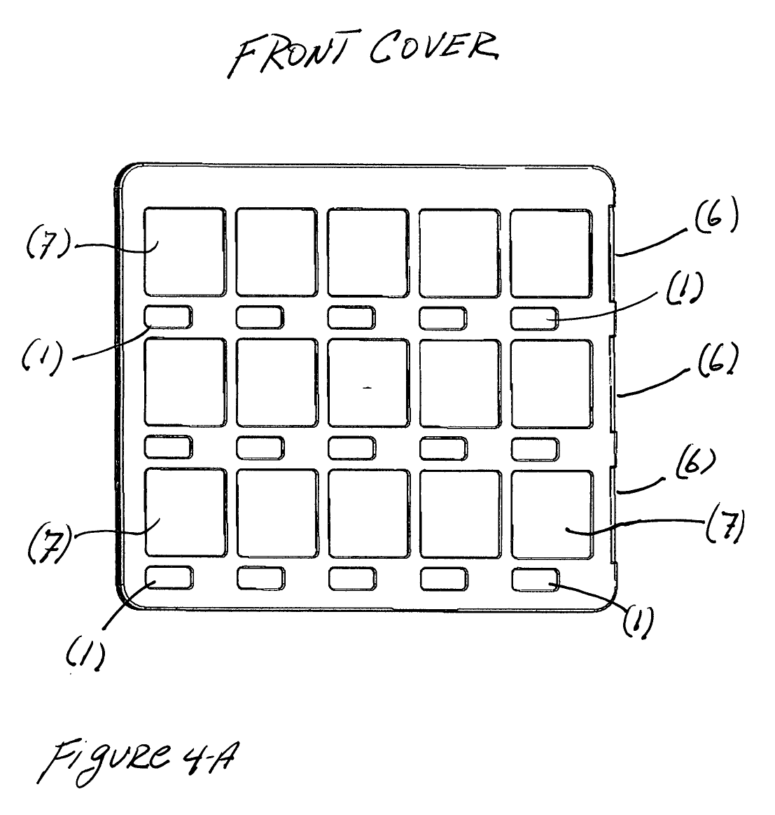

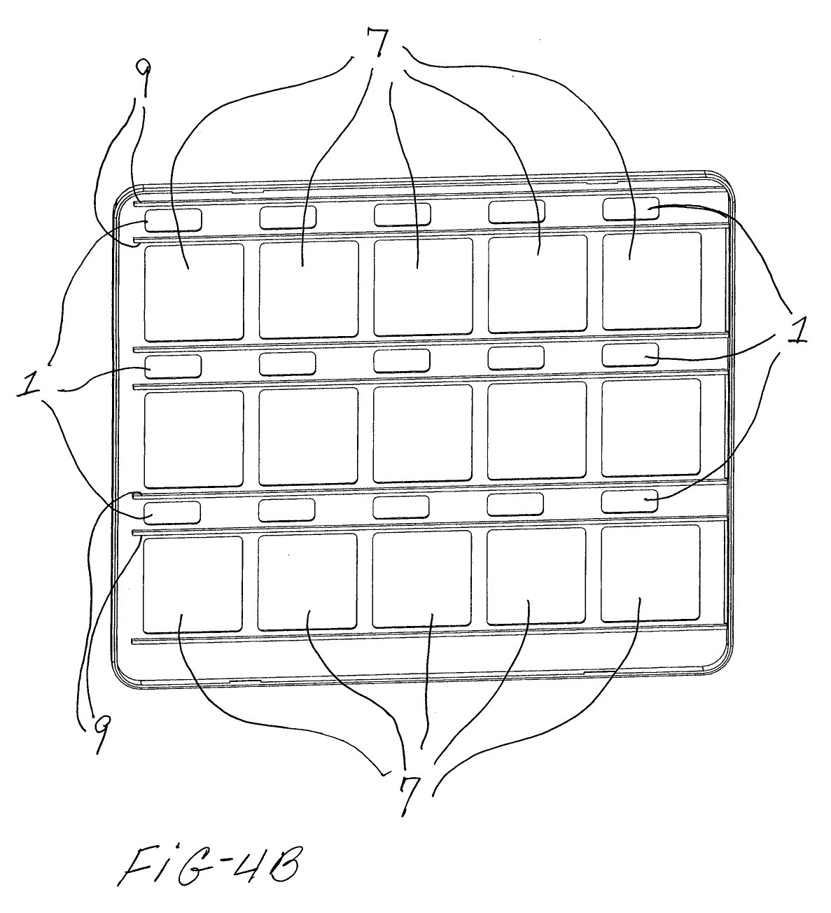

FIG. 4A The front cover houses the windows 7 to view the items on the interchangeable cards 8 and the buy window 1, as well as the slots 6.

FIG. 4b The reverse side of the front covers also houses windows 7 and the buy windows 1, and the sliding rails 9 for the slider.

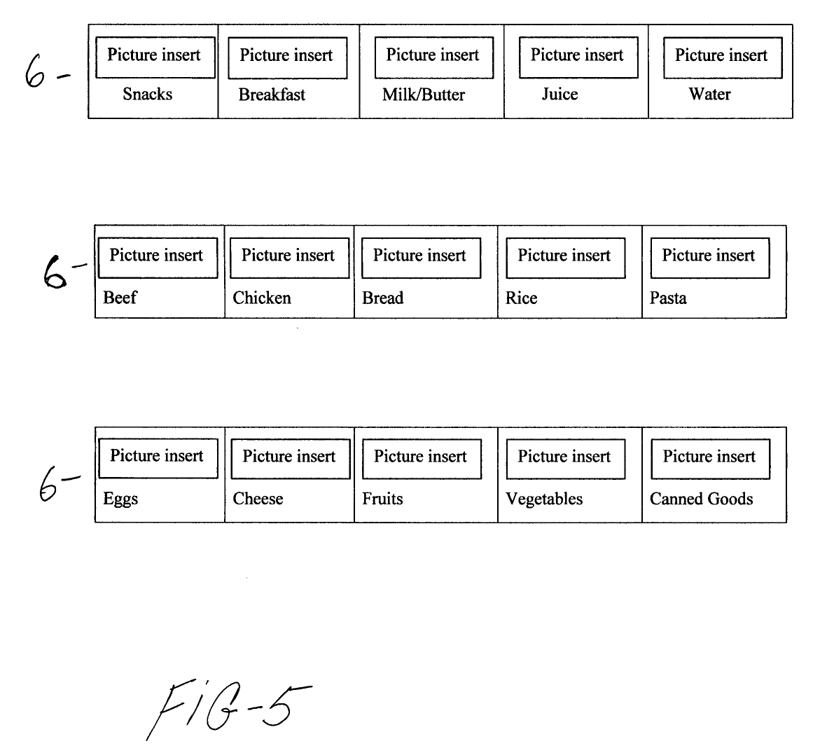

FIG. 5 Interchangeable cards with pictures of items slides into slot 6.

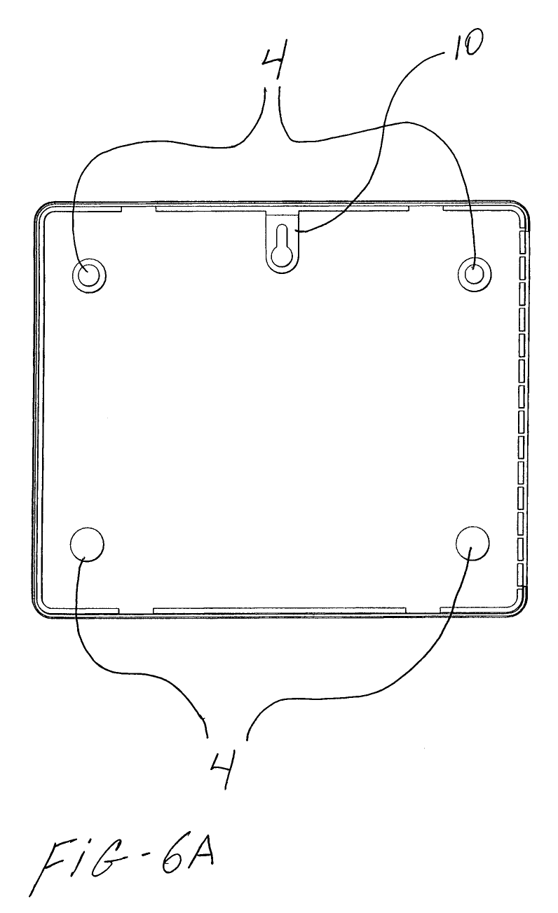

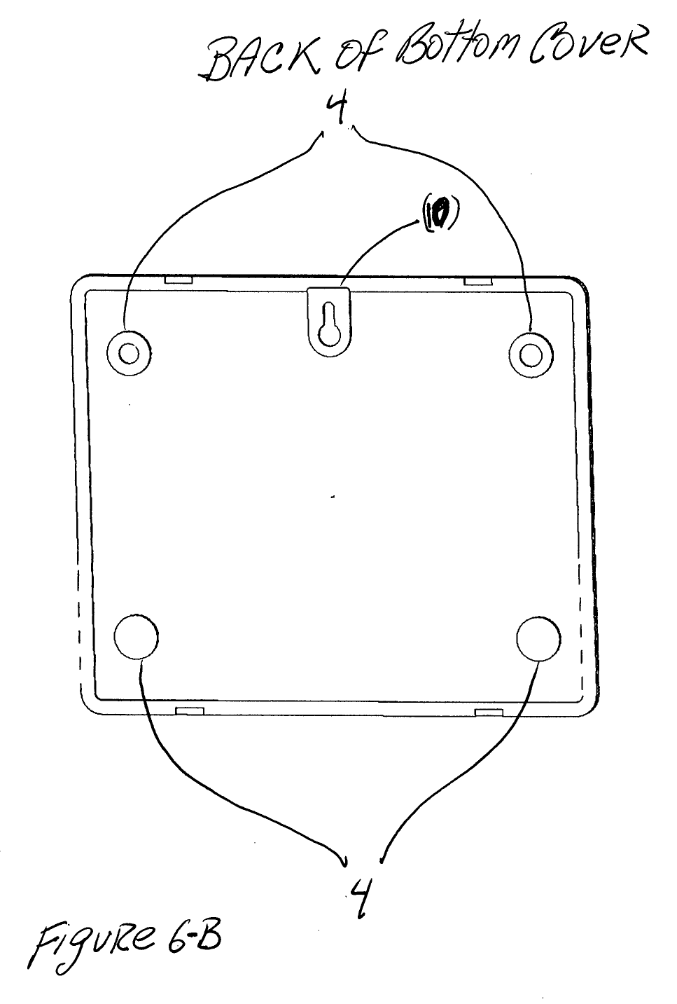

FIG. 6A Inside view of bottom cover of invention, which holds magnets 4 and for hanging a slit for a hook 10.

FIG. 6B Back of bottom cover of the invention, which holds magnets 4 and hanging slit for a hook 10.

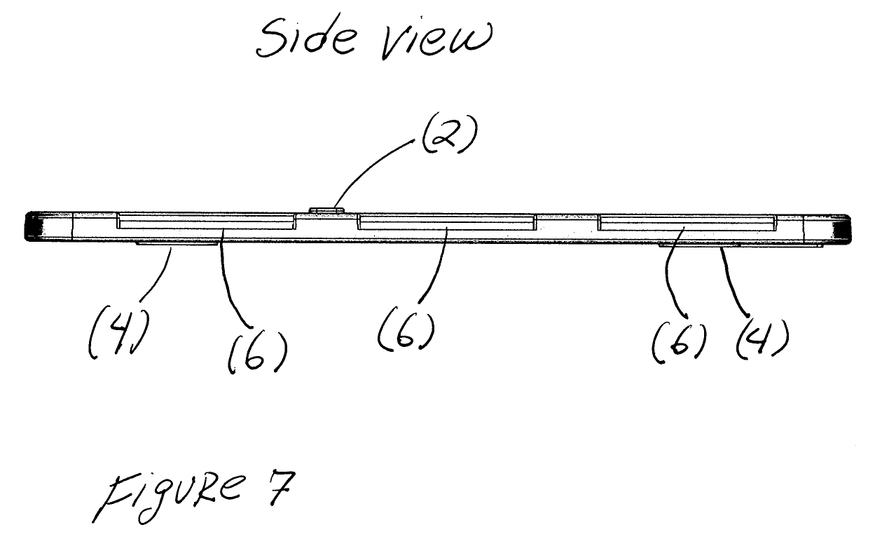

FIG. 7 Side view of the invention, which holds slider 2, magnets 4, slots 6.

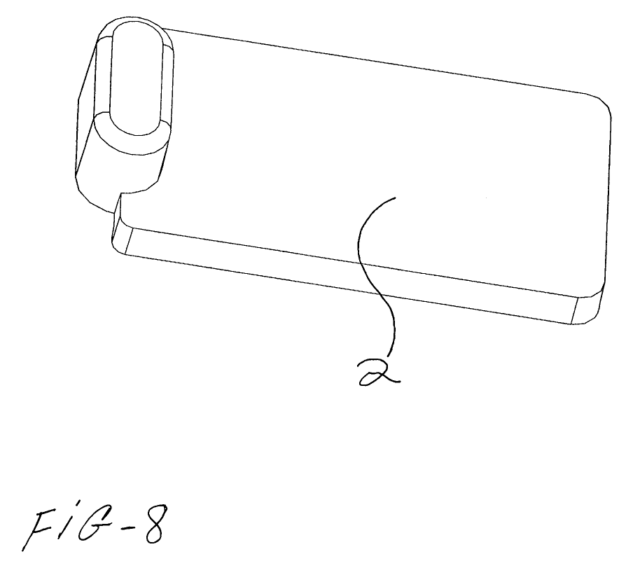

FIG. 8 Slider 2 moves back and forth revealing the buy sing.

1. Kitchen Butler a memorization household tool composed of plastic resin helps with the management of the kitchen and every day life. Which can be attached to a metal surface by magnets ex. Refrigerator, or by a hook located on the back of the kitchen butler, the front and back brackets are joined together to make a housing bracket creating the “kitchen Butler”, the three slots cut outs on kitchen butler consists of five vertical windows in its dimensions, which allows you to see the pictures on the cards of the imprinted item that can be slid between the kitchen butler via the slot cut outs in the housing bracket.

2. The kitchen Butler according to claim 1 where in the dimensions are 7¼ inches by 6 inches ⅛ in thickness.
